(19) United States
(12) Patent Application Publication
(10) Pub. No.: US 2014/0129931 A1
(43) Pub. Date: May 8, 2014

(54) ELECTRONIC APPARATUS AND HANDWRITTEN DOCUMENT PROCESSING METHOD

(71) Applicant: KABUSHIKI KAISHA TOSHIBA, Tokyo (JP)

(72) Inventor: Rumiko Hashiba, Kawasaki-shi (JP)

(21) Appl. No.: 13/922,703

(22) Filed: Jun. 20, 2013

(30) Foreign Application Priority Data
Nov. 2, 2012 (JP) 2012-242569

(51) Int. Cl. G06F 3/0488

(52) U.S. Cl. CPC G06F 3/04883
USPC 715/268

(57) ABSTRACT

According to one embodiment, an electronic apparatus includes a display processor and a selector. The display processor displays an area stroke on a screen when a first document including a plurality of strokes input by handwriting and one or more images is being displayed on the screen, the area stroke designating a first area. The selector selects first stroke data and first image data based on the area stroke, the first stroke data corresponding to a first stroke among the plurality of strokes, the first image data corresponding to a first part in the one or more images.

### CROSS-REFERENCE TO RELATED APPLICATIONS

This application is based upon and claims the benefit of priority from Japanese Patent Application No. 2012-242569, filed Nov. 2, 2012, the entire contents of which are incorporated herein by reference.

### FIELD

Embodiments described herein relate generally to processing of a handwritten document processing.

### BACKGROUND

In recent years, various kinds of electronic devices, such as a tablet, a PDA and a smartphone, have been developed. Most of these electronic devices include touch-screen displays for facilitating input operations by users.

By touching a menu or an object, which is displayed on the touch-screen display, by a finger or the like, the user can instruct an electronic device to execute a function which is associated with the menu or object.

In this kind of electronic devices, there is known an electronic device having a function for enabling the user to handwrite a character, graphic, etc., on the touch-screen display. A handwritten document (handwritten page) including such a handwritten character, graphic, etc., is stored and, where necessary, is browsed.

In the meantime, in many cases, software such as a text editor, which can create a document, has a function of copying (or cutting) a part of a created document and pasting the copied part on another area in this document or on another document (copy-and-paste function or cut-and-paste function).

Even with a handwritten document, in some cases, it is expected that a part of the handwritten document will be used in this handwritten document or another handwritten document.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic apparatus according to an embodiment.

FIG. 2 is a view illustrating an example of a handwritten document which is processed by the electronic apparatus of the embodiment.

FIG. 3 is an exemplary view for explaining time-series information corresponding to the handwritten document of FIG. 2, the time-series information being stored in a storage medium by the electronic apparatus of the embodiment.

FIG. 4 is an exemplary block diagram illustrating a system configuration of the electronic apparatus of the embodiment.

FIG. 5 is an exemplary block diagram illustrating a functional configuration of a digital notebook application program executed by the electronic apparatus of the embodiment.

FIG. 6 is a view illustrating an example of a handwritten document created by the electronic apparatus of the embodiment.

FIG. 7 is a view illustrating an example in which an area for selecting strokes is input on the handwritten document of FIG. 6.

FIG. 8 is a view illustrating examples of candidate areas which are determined based on the area of FIG. 7.

FIG. 9 is a view illustrating examples of strokes extracted in accordance with selection of a candidate area of FIG. 8.

FIG. 10 is a view illustrating an example of an operation of altering the area of FIG. 7.

FIG. 11 is a view illustrating an example of strokes extracted by the electronic apparatus of the embodiment.

FIG. 12 is a view illustrating an example in which an area for selecting strokes is input on a handwritten document including an image (object) which is created by the electronic apparatus of the embodiment.

FIG. 13 is a view illustrating examples of images and strokes, which are extracted based on the area of FIG. 12.

FIG. 14 is a view illustrating other examples of images and strokes, which are extracted based on the area of FIG. 12.

FIG. 15 is a view illustrating another example of the candidate area which is determined based the area of FIG. 7.

FIG. 16 is a view illustrating an example of strokes which are extracted based on the area of FIG. 15.

FIG. 17 is a flowchart illustrating an example of the procedure of a handwritten document input process executed by the electronic apparatus of the embodiment.

FIG. 18 is a flowchart illustrating an example of the procedure of an area select process executed by the electronic apparatus of the embodiment.

### DETAILED DESCRIPTION

Various embodiments will be described hereinafter with reference to the accompanying drawings.

In general, according to one embodiment, an electronic apparatus includes a display processor and a selector. The display processor is configured to display an area stroke on a screen when a first document including a plurality of strokes input by handwriting and one or more images is being displayed on the screen, the area stroke designating a first area. The selector is configured to select first stroke data and first image data based on the area stroke, the first stroke data corresponding to a first stroke among the plurality of strokes, the first image data corresponding to a first part in the one or more images.

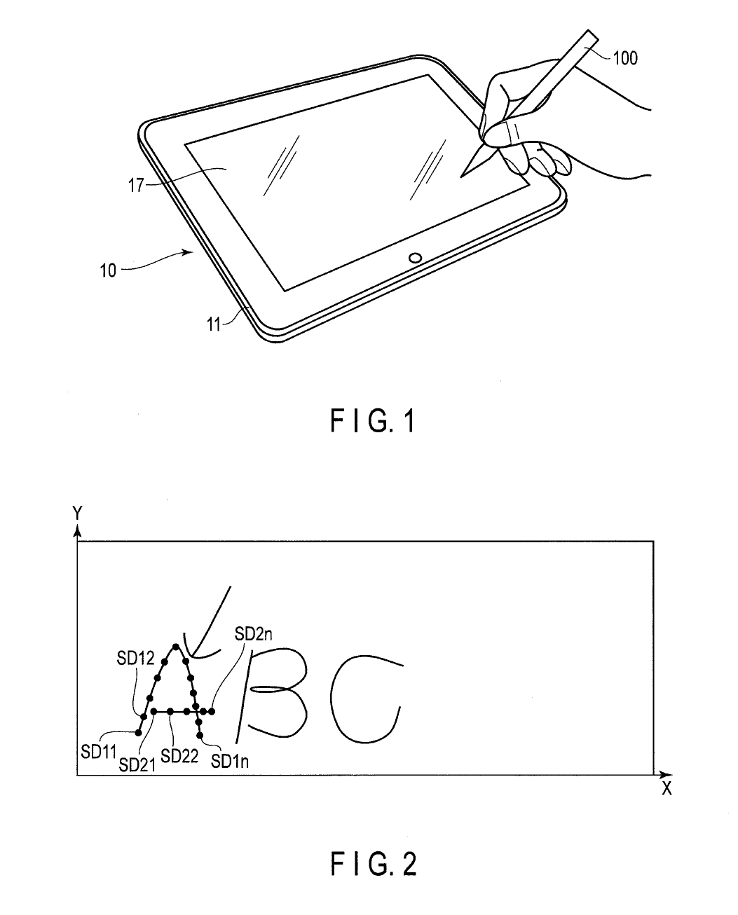

FIG. 1 is a perspective view illustrating an external appearance of an electronic apparatus according to an embodiment. The electronic apparatus is, for instance, a pen-based portable electronic apparatus which can execute a handwriting input by a pen or a finger. This electronic apparatus may be realized as a tablet computer, a notebook-type personal computer, a smartphone, a PDA, etc. In the description below, the case is assumed that this electronic apparatus is realized as a tablet computer 10. The tablet computer 10 is a portable electronic apparatus which is also called “tablet” or “slate computer”. As shown in FIG. 1, the tablet computer 10 includes a main body 11 and a touch-screen display 17. The touch-screen display 17 is attached such that the touch-screen display 17 is laid over the top surface of the main body 11.

The main body 11 has a thin box-shaped housing. In the touch-screen display 17, a flat-panel display and a sensor, which is configured to detect a touch position of a pen or a finger on the screen of the flat-panel display, are assembled. The flat-panel display may be, for instance, a liquid crystal display (LCD). As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17.

Each of the digitizer and the touch panel is provided in a manner to cover the screen of the flat-panel display. The touch-screen display 17 can detect not only a touch operation on the screen with use of a finger, but also a touch operation on the screen with use of a pen 100. The pen 100 may be, for instance, an electromagnetic-induction pen.

The user can execute a handwritten document input operation of inputting a plurality of strokes by handwriting, on the touch-screen display 17 by using an external object (pen 100 or finger). During the handwritten document input operation, loci (paths) of movement of the external object (pen 100 or finger) on the screen, that is, loci (writing traces) of strokes that are handwritten by the handwritten document input operation are drawn in real time. Thereby, the locus of each stroke is displayed on the screen. A locus of movement of the external object during a time in which the external object is in contact with the screen corresponds to one stroke. A handwritten document is composed of a set of many strokes corresponding to handwritten characters or graphics, that is, a set of many loci (writing traces).

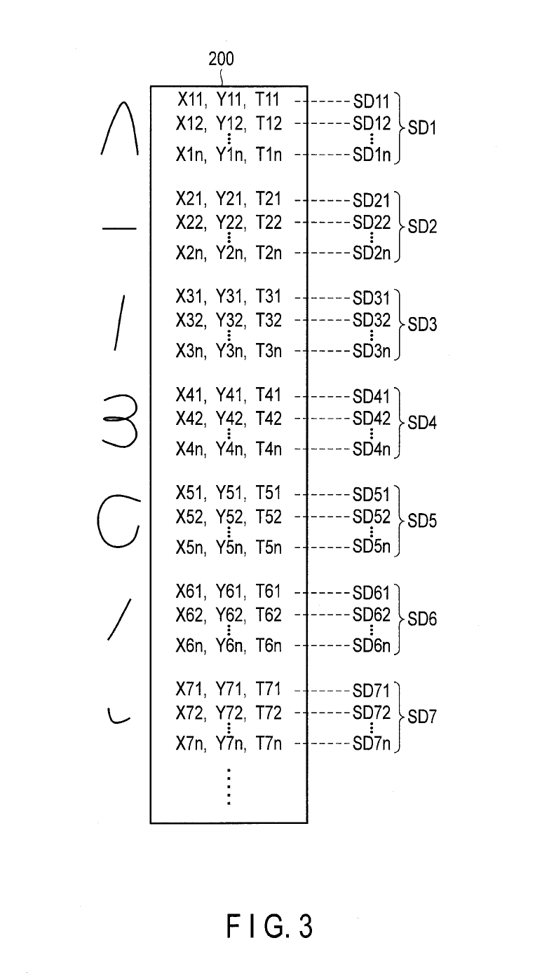

In the present embodiment, this handwritten document is stored in a storage medium not as image data but as handwritten document data including time-series information indicative of coordinate series of the loci of strokes and the order relation between the strokes. The details of this time-series information will be described later with reference to FIG. 3. In general, this time-series information means a set of time-series stroke data corresponding to a plurality of strokes. Each stroke data may be of any kind if it can express one stroke input by handwriting, and each stroke data includes coordinate data series (time-series coordinates) corresponding to points on the locus of this stroke. The order of arrangement of these stroke data corresponds to an order in which strokes were handwritten, that is, an order of strokes.

The tablet computer 10 can read arbitrary existing handwritten document data from the storage medium, and can display on the screen a handwritten document corresponding to this handwritten document data, that is, a handwritten document on which the loci corresponding to a plurality of strokes indicated by time-series information are drawn.

Furthermore, the user can execute an area input operation of inputting an area stroke for designating a first area, on the touch-screen display 17 by using the external object (pen 100 or finger). In this area input operation, an arbitrary area on a displayed handwritten document is designated. During the area input operation, like the handwritten document input operation, a locus of movement of the external object (pen 100 or finger) on the screen, that is, a locus (writing trace) of a stroke that is handwritten by the area input operation, is drawn in real time. Thereby, the locus of one stroke is displayed on the screen. A locus of movement of the external object during a time in which the external object is in contact with the screen corresponds to one stroke. In accordance with a range (first area) on the screen, which is designated by the handwritten single stroke (single-stroke writing), a target part (first part) on the handwritten document is selected (derived). Data of strokes or an object corresponding to the target part is clipped, and can be used in a document which is being processed or in another document.

The user can effect switching between a first mode of performing the handwritten document input operation and a second mode of performing the area input operation, for example, by a predetermined operation using an “area designation” tool or a button, etc. on the pen 100, attribute information associated with the pen, etc. Specifically, an input operation on the touch-screen display 17 is detected as a handwritten document input operation when the tablet computer 10 is in the first mode, and is detected as an area input operation when the tablet computer 10 is in the second mode. The attribute information associated with the pen includes, for example, information indicative of the type of pen. More specifically, the attribute information includes information indicative of the setting of “ball-point pen” or “marker pen” (e.g. the thickness, shape, color, transparency, etc. of the pen) or information indicative of the setting of the pen for inputting an area. The “ball-point pen” or “marker pen” is the type of pen, which is named so that the user may easily have an image of a stroke that is to be drawn. By this attribute information, the above-described first mode and second mode can also be discriminated.

In addition, the locus of an area stroke based on the area input operation may be drawn by a line of a kind which is different from the kind of the locus of a stroke based on the handwritten document input operation. For example, the locus of a stroke based on the handwritten document input operation is drawn by a solid line, and the locus of an area stroke based on the area input operation is drawn by a broken line.

Next, referring to FIGS. 2 and 3, a description is given of a relationship between strokes (characters, marks, graphics, tables, etc.), which are handwritten by the user, and time-series information. FIG. 2 shows an example of a handwritten document (handwritten character string) which is handwritten on the touch-screen display 17 by using the pen 100 or the like.

In many cases, on a handwritten document, other characters or graphics are handwritten over already handwritten characters or graphics. In FIG. 2, the case is assumed that a handwritten character string “ABC” was handwritten in the order of “A”, “B” and “C”, and thereafter a handwritten arrow was handwritten near the handwritten character “A”.

The handwritten character “A” is expressed by two strokes (a locus of “Λ” shape and a locus of “-” shape) which are handwritten by using the pen 100 or the like, that is, by two loci. The locus of the pen 100 of the first handwritten “Λ” shape is sampled in real time, for example, at regular time intervals, and thereby time-series coordinates SD11, SD12, . . . , SD1n of the stroke of the “Λ” shape are obtained. Similarly, the locus of the pen 100 of the next handwritten “-” shape is sampled, and thereby time-series coordinates SD21, SD22, . . . , SD2n of the stroke of the “-” shape are obtained.

The handwritten character “B” is expressed by two strokes which are handwritten by using the pen 100 or the like, that is, by two loci. The handwritten character “C” is expressed by one stroke which is handwritten by using the pen 100 or the like, that is, by one locus. The handwritten arrow is expressed by two strokes which are handwritten by using the pen 100 or the like, that is, by two loci.

FIG. 3 illustrates time-series information 200 corresponding to the handwritten document of FIG. 2. The time-series information 200 includes a plurality of stroke data SD1, SD2, . . . , SD7. In the time-series information 200, the stroke data SD1, SD2, . . . , SD7 are arranged in time series in the order of strokes, that is, in the order in which plural strokes were handwritten.

In the time-series information 200, the first two stroke data SD1 and SD2 are indicative of two strokes of the handwritten character “A”. The third and fourth stroke data SD3 and SD4 are indicative of two strokes of the handwritten character “B”. The fifth stroke data SD5 is indicative of one stroke of the handwritten character “C”. The sixth and seventh stroke data SD6 and SD7 are indicative of two strokes of the handwritten arrow.

Each stroke data includes coordinate data series (time-series coordinates) corresponding to one stroke, that is, a plurality of coordinates corresponding to a plurality of points on the locus of one stroke. In each stroke data, the plural coordinates are arranged in time series in the order in which the stroke is written. For example, as regards handwritten character “A”, the stroke data SD1 includes coordinate data series (time-series coordinates) corresponding to the points on the locus of the stroke of the handwritten “Λ” shape of the handwritten character “A”, that is, an n-number of coordinate data SD11, SD12, . . . , SD1n. The stroke data SD2 includes coordinate data series corresponding to the points on the locus of the stroke of the handwritten “-” shape of the handwritten character “A”, that is, an n-number of coordinate data SD21, SD22, . . . , SD2n. Incidentally, the number of coordinate data may differ between respective stroke data.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “Λ” shape. The coordinate data SD1n is indicative of an X coordinate (X1n) and a Y coordinate (Y1n) of the end point of the stroke of the “Λ” shape.

Further, each coordinate data may include time stamp information T corresponding to a time point at which a point corresponding to this coordinate data was handwritten. The time point at which the point was handwritten may be either an absolute time (e.g. year/month/day/hour/minute/second) or a relative time with reference to a certain time point. For example, an absolute time (e.g. year/month/day/hour/minute/second) at which a stroke began to be handwritten may be added as time stamp information to each stroke data, and furthermore a relative time indicative of a difference from the absolute time may be added as time stamp information T to each coordinate data in the stroke data.

In this manner, by using the time-series information in which the time stamp information T is added to each coordinate data, the temporal relationship between strokes can be more precisely expressed.

Moreover, information (Z) indicative of a pen stroke pressure may be added to each coordinate data.

Furthermore, in the present embodiment, as described above, a handwritten document is stored not as an image or a result of character recognition, but as the time-series information 200 which is composed of a set of time-series stroke data. Thus, handwritten characters and graphics can be handled, without depending on languages. Therefore, the structure of the time-series information 200 of the present embodiment can be commonly used in various countries of the world where different languages are used.

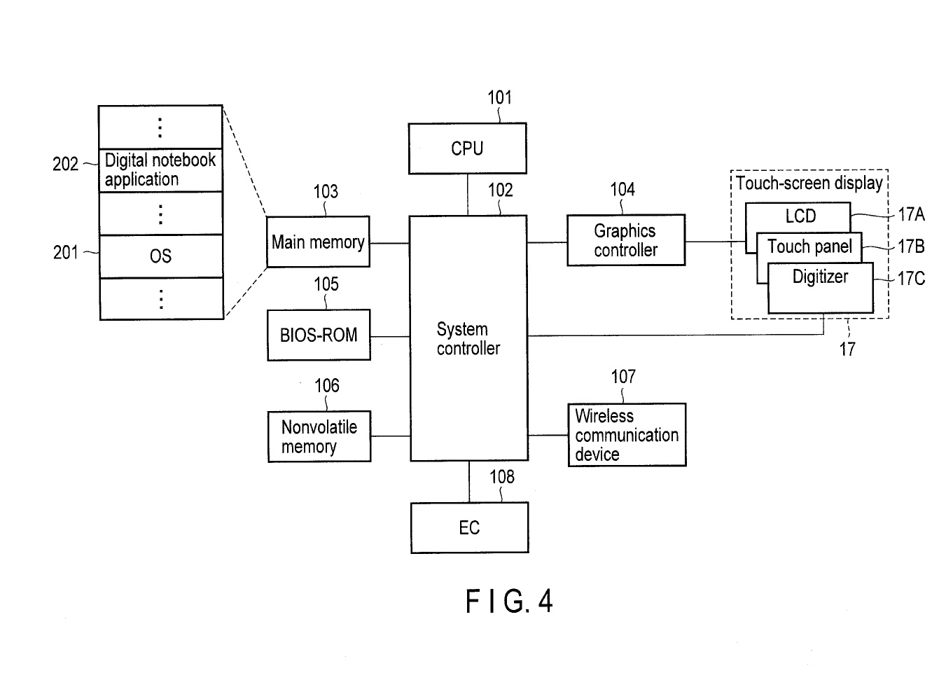

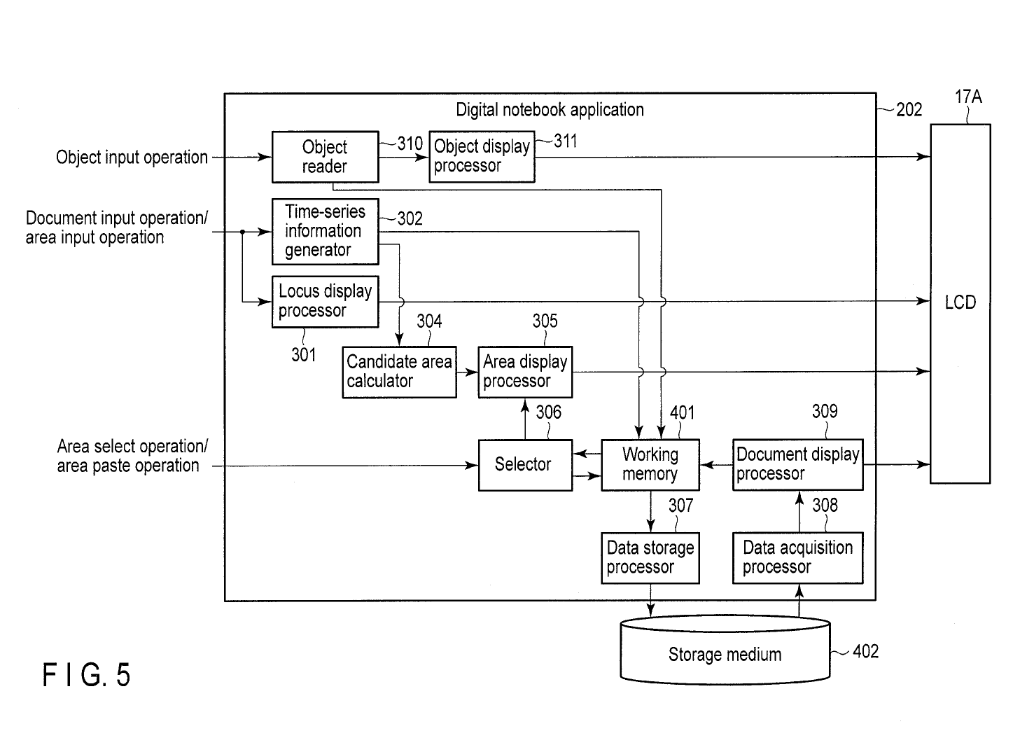

FIG. 4 shows a system configuration of the tablet computer 10.

As shown in FIG. 4, the tablet computer 10 includes a CPU 101, a system controller 102, a main memory 103, a graphics controller 104, a BIOS-ROM 105, a nonvolatile memory 106, a wireless communication device 107, and an embedded controller (EC) 108.

The CPU 101 is a processor which controls the operations of various modules in the tablet computer 10. The CPU 101 executes various kinds of software, which are loaded from the nonvolatile memory 106 that is a storage device into the main memory 103. The software includes an operating system (OS) 201 and various application programs. The application programs include a digital notebook application program 202. The digital notebook application program 202 includes a function of creating and displaying the above-described handwritten document, and a clipping function of clipping an arbitrary area or an arbitrary stroke from a handwritten document.

In addition, the CPU 101 executes a basic input/output system (BIOS) stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal, which is generated by the graphics controller 104, is sent to the LCD 17A. The LCD 17A displays a screen image based on the display signal. A touch panel 17B and a digitizer 17C are disposed on the LCD 17A. The touch panel 17B is an electrostatic capacitance-type pointing device for executing an input on the screen of the LCD 17A. The touch panel 17B detects a contact position on the screen, which is touched by a finger, and a movement of the contact position. The digitizer 17C is an electromagnetic induction-type pointing device for executing an input on the screen of the LCD 17A. The digitizer 17C detects a contact position on the screen, which is touched by the pen 100, and a movement of the contact position.

The wireless communication device 107 is a device configured to execute wireless communication such as wireless LAN or 3G mobile communication. The EC 108 is a one-chip microcomputer including an embedded controller for power management. The EC 108 includes a function of powering on or powering off the tablet computer 10 in accordance with an operation of a power button by the user.

Next, referring to FIG. 5, a description is given of a functional configuration of the digital notebook application program 202. The digital notebook application program 202 executes creation, display and edit of a handwritten document, by using stroke data input by a handwritten document input operation using the touch-screen display 17. In addition, in accordance with an area input operation of designating an area in a handwritten document, the digital notebook application program 202 acquires image data of an image corresponding or relating to the designated area, and/or stroke data of a stroke corresponding or relating to the designated area.

The digital notebook application program 202 includes, for example, a locus display processor 301, a time-series information generator 302, a candidate area calculator 304, an area display processor 305, a selector 306, a data storage processor 307, a data acquisition processor 308, a document display processor 309, an object reader 310, and an object display processor 311.

The touch-screen display 17 is configured to detect the occurrence of events such as “touch”, “move (slide)” and “release”. The “touch” is an event indicating that an external object has come in contact with the screen. The “move (slide)” is an event indicating that the position of contact of the external object has been moved while the external object is in contact with the screen. The “release” is an event indicating that the external object has been released from the screen.

The locus display processor 301 and time-series information generator 302 receive an event “touch” or “move (slide)” which is generated by the touch-screen display 17, thereby detecting a handwritten document input operation (or an area input operation). The “touch” event includes coordinates of a contact position. The “move (slide)” event includes coordinates of a contact position at a destination of movement. Thus, the locus display processor 301 and time-series information generator 302 can receive coordinate series, which correspond to the locus of movement of the contact position, from the touch-screen display 17.

The locus display processor 301 receives coordinate series from the touch-screen display 17. The locus display processor 301 then displays, based on the coordinate series, the locus of each stroke, which is handwritten by a handwritten document input operation (or an area input operation) with use of the pen 100 or the like, on the screen of the LCD 17A in the touch-screen display 17. By the locus display processor 301, the locus of the pen 100 during a time in which the pen 100 is in contact with the screen, that is, the locus of each stroke, is drawn on the screen of the LCD 17A.

The time-series information generator 302 receives the above-described coordinate series output from the touch-screen display 17, and then generates, based on the coordinate series, the above-described time-series information (stroke data) having the structure as described in detail with reference to FIG. 3. In this case, the time-series information, that is, the coordinates and time stamp information corresponding to the respective points of each stroke, may be temporarily stored in a working memory 401.

The data storage processor 307 stores the generated time-series information (the time-series information temporarily stored in the working memory 401) as handwritten document data in a storage medium 402. The storage medium 402 is, for example, a storage device in the tablet computer 10.

The data acquisition processor 308 reads from the storage medium 402 arbitrary handwritten document data which is already stored in the storage medium 402. The read handwritten document data is sent to the document display processor 309. The document display processor 309 analyzes the handwritten document data and then displays, based on the analysis result, the locus of each stroke indicated by the time-series information on the screen as a handwritten document (handwritten page).

As has been described above, in the time-series information which corresponds to a handwritten document, a plurality of stroke data, which correspond to a plurality of strokes handwritten on the handwritten document, are arranged in time series. Each stroke data includes coordinate data series corresponding to one stroke, that is, a plurality of coordinates corresponding to a plurality of time-series points on the locus of one stroke. By using such time-series information, the strokes handwritten on the handwritten document can be divided into groups based on time points at which the strokes were handwritten.

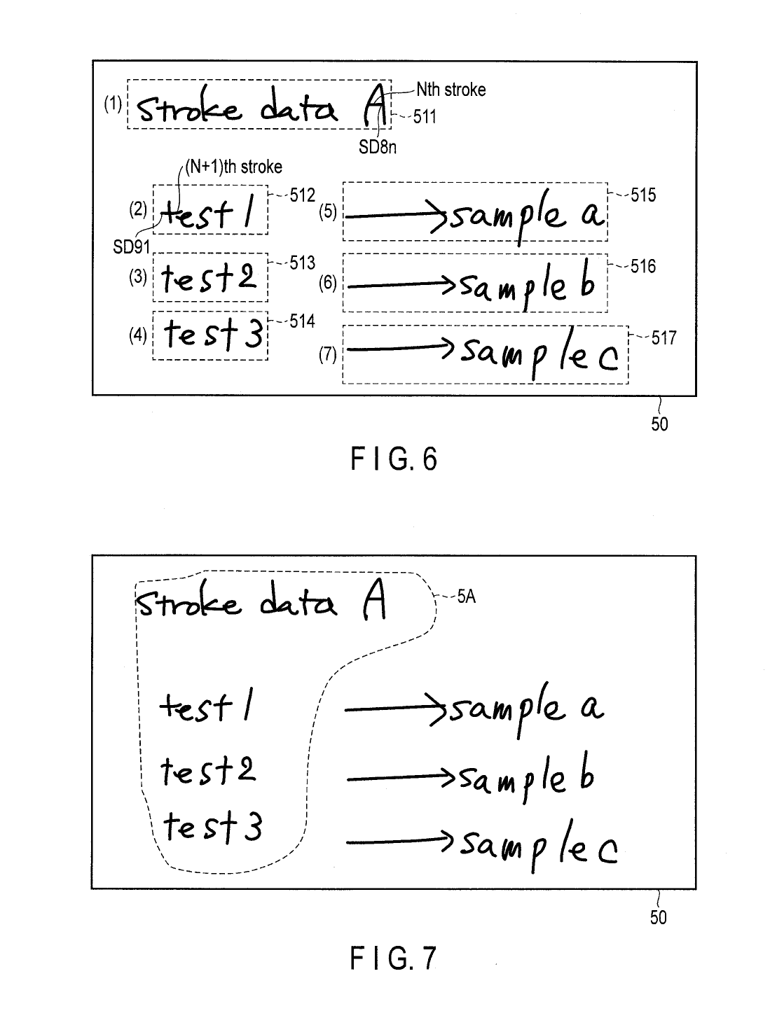

As illustrated in FIG. 6, in a handwritten document 50, a plurality of strokes are divided into seven stroke groups 511 to 517 by detecting intervals of input time points between the strokes, based on time points at which the strokes were handwritten. For example, using time-series information, the time-series information generator 302 determines that an Nth stroke and an (N+1)th stroke belong to different stroke groups, if an elapsed time from a time point of completion of input of the Nth stroke (i.e. a time point associated with last coordinates SD8n of the Nth stroke) to a time point of start of input of the (N+1)th stroke which follows the Nth stroke (i.e. a time point associated with first coordinates SD91 of the (N+1)th stroke) is a threshold time or more.

By repeating the above-described determination, the time-series information generator 302 divides the strokes on the handwritten document 50 into seven stroke groups 511 to 517. Accordingly, these seven stroke groups 511 to 517 are time-series groups. Information indicative of the stroke groups may be temporarily stored in the working memory 401.

In addition, by an area input operation using the “area designation” tool, the user can designate an arbitrary part of the handwritten document 50 (time-series information) which is being displayed. In accordance with an area designated by the area input operation, the selector 306 selects strokes of a process target.

As illustrated in FIG. 7, for example, the user designates a first area in the handwritten document 50 by executing an area input operation of handwriting one stroke (area stroke) 5A in the handwritten document 50.

As described above, the locus display processor 301 receives, coordinate series from the touch-screen display 17. The locus display processor 301 then displays, based on the coordinate series, the locus of the area stroke 5A, which is handwritten by the area input operation using the pen 100 or the like, on the screen of the LCD 17A in the touch-screen display 17.

In addition, the time-series information generator 302 receives the above-described coordinate series from the touch-screen display 17, and then generates, based on the coordinate series, time-series information (stroke data) having the structure as described in detail with reference to FIG. 3. Specifically, the time-series information generator 302 generates stroke data corresponding to the area stroke 5A based on the area input operation. In this case, the stroke data, namely the coordinates and time stamp information corresponding to each point of the stroke, may be temporarily stored in the working memory 401.

Then, the candidate area calculator 304 determines a first candidate area corresponding to the area stroke 5A, by using the generated stroke data. The area stroke 5A constitutes, for example, a closed loop. In this case, the candidate area calculator 304 determines an area corresponding to this closed loop to be the first candidate area. Incidentally, the area stroke 5A may not constitute a closed loop. In this case, the candidate area calculator 304 estimates a closed loop based on the area stroke 5A by linearly or non-linearly interpolating a stroke portion between the beginning and end of the area stroke 5A, and determines an area corresponding to the estimated closed loop to be the first candidate area.

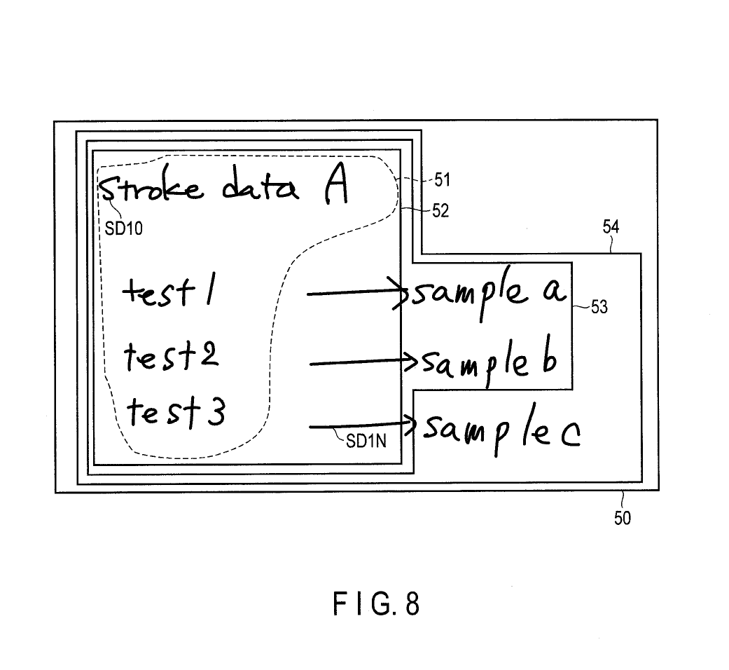

The candidate area calculator 304 further calculates candidate areas, based on the area stroke 5A (or the first candidate area). FIG. 8 illustrates examples of the first candidate area 51 and candidate areas 52, 53 and 54 calculated by the candidate area calculator 304.

The candidate area calculator 304 calculates, for example, a rectangle including the area stroke 5A (first candidate area 51) (e.g. a rectangle circumscribing the first candidate area 51) as a second candidate area 52. This second candidate area 52 is, for example, a rectangular area which is composed of two sides which are parallel to the horizontal direction of the handwritten document 50 and two sides which are parallel to the vertical direction of the handwritten document 50.

In addition, the candidate area calculator 304 calculates an area including an offset using time information of time points at which a plurality of strokes in the handwritten document 50 were handwritten, so that a semantic relation between the strokes in the handwritten document may be complemented. The candidate area calculator 304 detects, for example, from the plural strokes in the handwritten document 50, strokes which are at least partly included in the calculated rectangular area (second candidate area) 52, and calculates a period in which the detected strokes were handwritten. Then, the candidate area calculator 304 detects, from the plural strokes in the handwritten document 50, strokes which were handwritten during the determined period, and calculates a third candidate area 53 including these strokes. In the example illustrated in FIG. 8, a period from a time point at which a stroke SD10 was handwritten to a time point at which a stroke SD1N was handwritten is calculated, and strokes handwritten during this period are further detected. Specifically, strokes corresponding to “sample a” and strokes corresponding to “>sample b” are further detected. Then, the candidate area calculator 304 determines a third candidate area 53 including the detected strokes.

Furthermore, the candidate area calculator 304 detects, for example, from the plural strokes in the handwritten document 50, strokes which are at least partly included in the calculated rectangular area (second candidate area) 52, and calculates a fourth candidate area 54 which further includes strokes belonging to the same stroke group as each of the detected strokes. In the example illustrated in FIG. 8, strokes of “sample a”, strokes of “>sample b” and strokes of “>sample c” are detected as strokes belonging to the same stroke groups 515, 516 and 517 as the strokes which are at least partly included in the rectangular area (second candidate area) 52. Then, the fourth candidate area 54 which further includes these strokes is determined. The stroke groups are as have been described with reference to FIG. 6.

The area display processor 305 displays the calculated candidate areas 51, 52, 53 and 54 on the display 17A. The user executes an area select operation of selecting, for example, an area corresponding to strokes which are to be selected, from among the displayed candidate areas 51, 52, 53 and 54.

The selector 306 determines the area which has been selected by the user from among the candidate areas 51, 52, 53 and 54, in accordance with the area select operation using the touch-screen display 17. Then, based on the area selected by the user, the selector 306 selects strokes (hereinafter referred to also as “target block”) among the plural strokes on the handwritten document 50, based on the area selected by the user. Besides, when the area has been selected by the area select operation, the area display processor 305 may erase the candidate areas 51, 52, 53 and 54 from the screen.

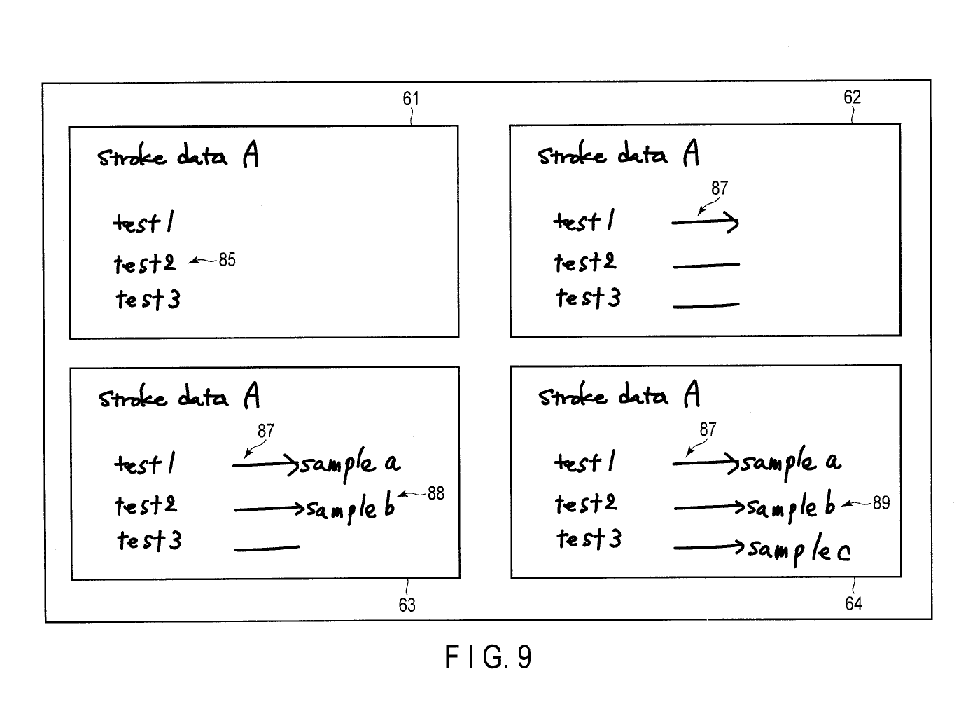

FIG. 9 illustrates examples of strokes (target block) which are selected by the selector 306 in accordance with the area select operation.

A target block 61 includes a plurality of strokes 85 which are included in the first candidate area 51 corresponding to the area stroke 5A. A target block 62 includes a plurality of first strokes 87 which are at least partly included in the second candidate area (the rectangular area including the area stroke 5A) 52.

A target block 63 includes strokes which are included in the third candidate area 53. Specifically, the target block 63 includes a plurality of first strokes 87 which are at least partly included in the rectangular area 52 including the area stroke 5A, and a plurality of second strokes 88 (i.e. “sample a” and “>sample b”) which were handwritten during the period in which the plural first strokes 87 were handwritten. That is, the selector 306 sets an offset of an area by using information of time points at which the strokes were handwritten. The second strokes 88 are strokes which were handwritten at time points between that one of the first strokes, which was handwritten at the earliest time point, and that one of the first strokes, which was handwritten at the last time point.

A target block 64 includes strokes which are included in the fourth candidate area 54. Specifically, the target block 64 includes a plurality of first strokes 87 which are at least partly included in the rectangular area 52 including the area stroke 5A, and a plurality of third strokes 89 (i.e. “sample a”, “>sample b” and “>sample c”) which belong to the same groups as the plural first strokes 87. The third strokes 89 are strokes which were handwritten continuous with the plural first strokes 87.

The selector 306 selects one or more stroke data corresponding to a selected target block (i.e. selected one or more strokes) from a plurality of stroke data (time-series information) corresponding to a plurality of strokes handwritten on the handwritten document 50. The selected one or more stroke data are, for example, a copy of a part of the plural stroke data (time-series information). The selected stroke data is temporarily stored, for example, in the working memory 401. In the meantime, the selector 306 may generate data of an image (clipping image) in which the selected stroke is drawn and store the generated data.

The selector 306 further reads the temporarily stored stroke data in accordance with an area paste operation using the touch-screen display 17. The read stroke data is sent to the area display processor 305. The area display processor 305 analyzes the stroke data and then displays (draws) in a target document the locus of each stroke indicated by the stroke data, based on the analysis result. This target document is a document which is set in an active state when the area paste operation is executed, and is, for example, the handwritten document (first document) 50 or a handwritten document (second document) which is different from the handwritten document 50.

In the meantime, when a plurality of candidate areas are displayed on the handwritten document 50, the area display processor 305 may effect such display that strokes, which are obtained (cut out) when each of the plural candidate areas is selected, can be discriminated by the user.

By the above-described configuration, the user can easily select not only the area 51 corresponding to the area stroke 5A, which was input by the area input operation, but also the areas 52, 53 and 54 relating to the area stroke 5A. In addition, by pasting the strokes corresponding to the selected area on the handwritten document 50 or another handwritten document, the user can easily execute edit of handwritten documents, such as reconstruction of the handwritten document 50 or integration of a plurality of handwritten documents. The areas 52, 53 and 54 relating to the area stroke 5A may present to the user an area including strokes having a relativity of which the user is not aware. Thus, the user can confirm the areas 52, 53 and 54 relating to the area stroke 5A as annotations or suggestions at a time of editing handwritten documents, and can efficiently execute edit of the handwritten documents.

In the meantime, the area stroke 5A can be altered after the input of the area stroke 5A was completed.

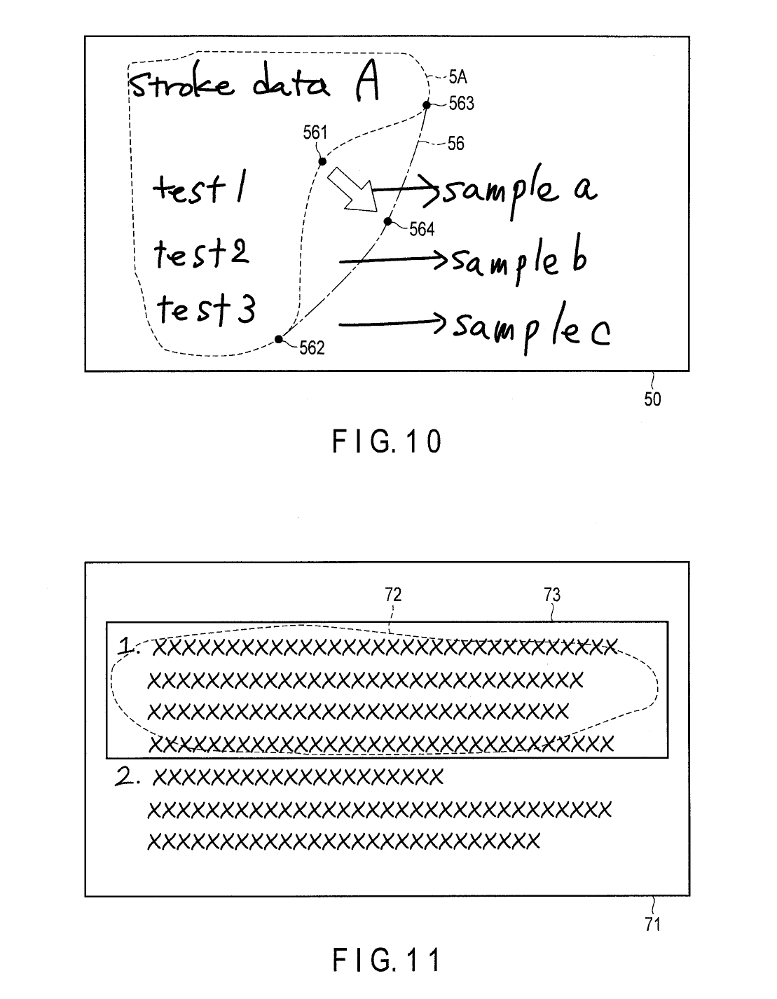

FIG. 10 illustrates an example in which the area stroke 5A is corrected. In this example, it is assumed that the user has executed an operation of dragging a point 561 on the area stroke 5A to a point 564 by using the touch-screen display 17.

The candidate area calculator 304 and area display processor 305 display on the screen a corrected area stroke 56 by linearly or non-linearly interpolating a stroke portion between a point 562 on the area stroke 5A and the point 564, and a stroke portion between the point 564 and a point 563 on the area stroke 5A. The candidate area calculator 304 calculates a candidate area, based on the corrected area stroke 56, and the area display processor 305 displays the calculated candidate area on the screen.

Thereby, for example, when an input area stroke is not a stroke intended by the user, this input area stroke can easily be corrected.

FIG. 11 illustrates another example of strokes selected based on the area stroke. On a handwritten document 71, strokes included in an area, which has been calculated based on an area stroke 72, are selected from among a plurality of strokes on the handwritten document 71. An area 73 includes a plurality of first strokes which are at least partly included in the area stroke 72 (the area corresponding to the area stroke 72), and strokes which were handwritten continuously before or after these plural first strokes.

By this selection of strokes, the user can easily select the area 73 corresponding to a group of strokes, such as a paragraph, by simply inputting the area stroke 72 which designates a rough area.

On the handwritten document 50, images or various objects may further be arranged.

The object reader 310 and object display processor 311 dispose on the handwritten document 50 an object such as an image, a graphic, a file path, an icon indicative of a link to a file, a URL, a formula, or a graph, in accordance with an object input operation using the touch-screen display 17. The user executes an object input operation of selecting an object, which is to be disposed on the handwritten document 50, for example, from a list of various objects, and designating a position on the handwritten document 50, at which the selected object is to be disposed.

The object reader 310 reads the object, which has been selected by the object input operation, from a storage such as the storage medium 402. The object display processor 311 displays the read object at the position designated by the object input operation. Incidentally, the object reader 310 may temporarily store object information indicative of the read object in the working memory 401. The data storage processor 307 stores the generated time-series information (the time-series information temporarily stored in the working memory 401) and the object information (the object information temporarily stored in the working memory 401) as handwritten document data in the storage medium 402.

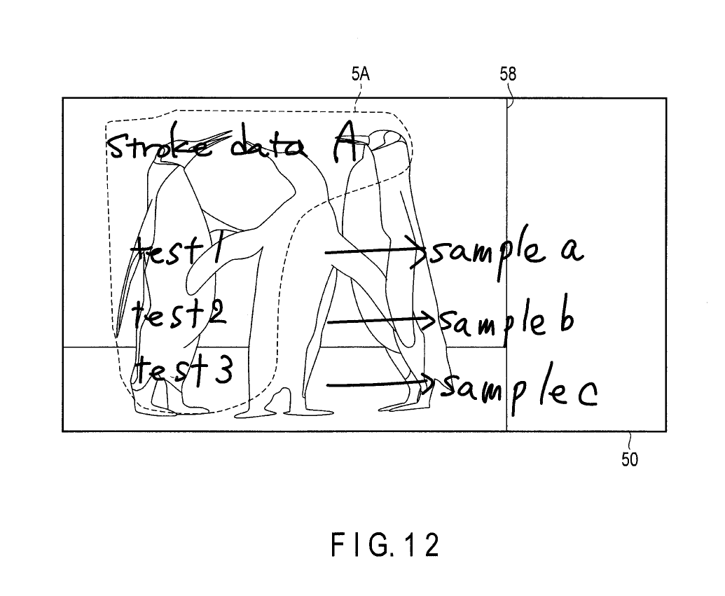

The object can be disposed at an arbitrary position in the handwritten document 50. As illustrated in FIG. 12, an image 58 can also be disposed as a background image of the handwritten document 50. In addition, after the object (image) is disposed, characters or graphics may be handwritten by a handwritten document input operation.

Even in the handwritten document 50 in which the object (image) 58 and strokes are mixed, the user can designate an arbitrary part of the handwritten document 50 by an area input operation using the “area designation” tool. In accordance with an area designated by the area input operation, strokes and an object, which are a process target, are selected by the selector 306. When a handwritten document (first document) including strokes and one or more images (objects) 58 is being displayed on the screen, the selector 306 selects first stroke data corresponding to a first stroke of the strokes and first image data corresponding to a first part in the images, based on an area stroke for designating a first area.

In the example illustrated in FIG. 12, the handwritten document 50, in which the image 58 is disposed on the background and strokes handwritten on the image 58, is displayed. In this example, an area in the handwritten document 50, which includes a part of the image 58, is designated in accordance with an area input operation of handwriting one stroke (area stroke) 5A.

When the handwritten document (first document) including plural strokes and one or more images corresponding to the handwritten document input operation is being displayed, the locus display processor 301 displays the locus of the area stroke 5A, which is handwritten in accordance with the area input operation, on the screen of the LCD 17A in the touch-screen display 17. In addition, the time-series information generator 302 generates stroke data (coordinate data series) corresponding to the area stroke 5A.

The selector 306 selects, based on the area stroke 5A, a first stroke among the plural strokes and a first part in one or more images in the handwritten document. Then, the selector 306 selects first stroke data corresponding to the selected stroke from plural stroke data corresponding to the plural strokes, and selects first image data corresponding to the selected first part from one or more image data corresponding to the one or more images.

To be more specific, as has been described in detail with reference to FIG. 8, the candidate area calculator 304 and area display processor 305 calculate a plurality of candidate areas, based on the area stroke 5A, and display the plural candidate areas on the screen. In response to selection of one area from among the displayed plural candidate areas, the selector 306 selects a first stroke corresponding to the one area from the plural strokes in the handwritten document 50 and selects a first part corresponding to the one area in the image 58 in the handwritten document 50.

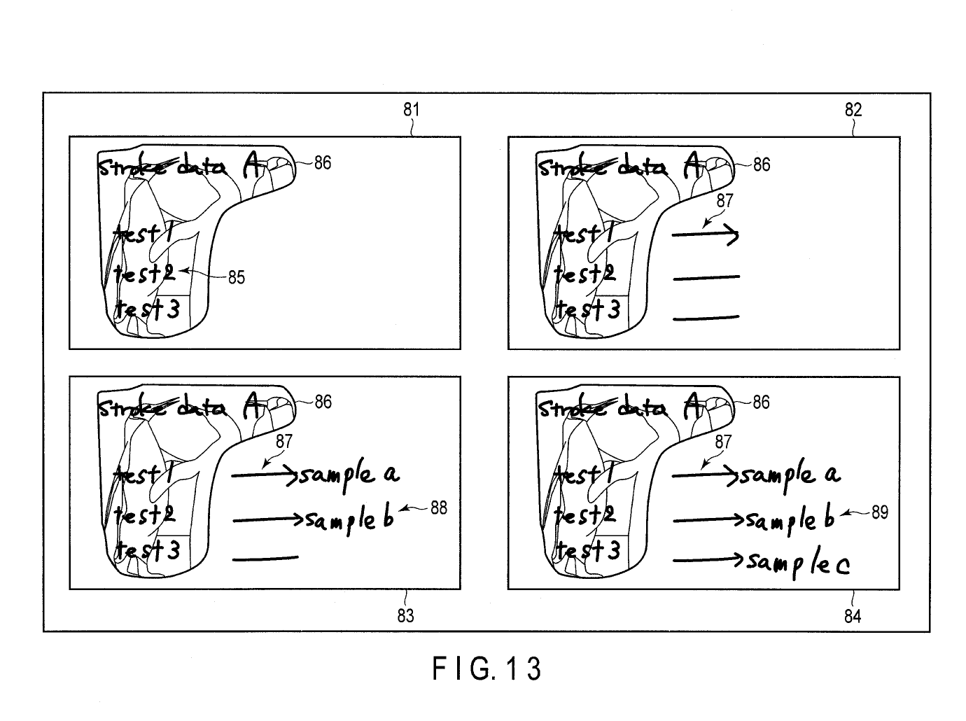

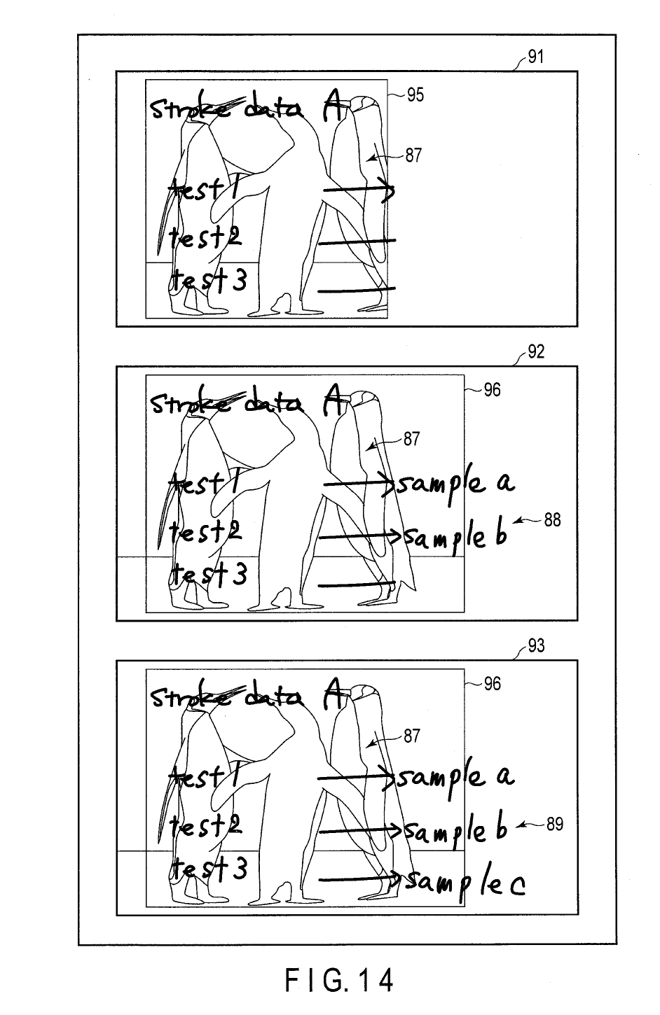

FIGS. 13 and 14 illustrate examples of strokes and an image part (first part), which are selected by the selector 306 in accordance with an area select operation.

A target block 81 illustrated in FIG. 13 includes a plurality of strokes 85 and an image part (first part) 86, which are included in the first area in the handwritten document 50 corresponding to the area stroke 5A. A target block 82 includes a plurality of first strokes 87 which are at least partly included in the rectangular area 52 including the area stroke 5A (e.g. the rectangular area circumscribing the area stroke 5A), and the image part (first part) 86 included in the first area corresponding to the area stroke 5A.

A target block 83 includes a plurality of first strokes 87 which are at least partly included in the rectangular area 52 including the area stroke 5A, a plurality of second strokes 88 (i.e. “sample a” and “>sample b”) which were handwritten during the period in which the plural first strokes 87 were handwritten. The target block 83 further includes an image part (first part) 86 included in the first area corresponding to the area stroke 5A. Specifically, the selector 306 sets an offset of an area using time information of time points at which the strokes were handwritten. The second strokes 88 are strokes which were handwritten at time points between that one of the first strokes 87, which was handwritten at the earliest time point, and that one of the first strokes 87, which was handwritten at the last time point.

A target block 84 includes a plurality of first strokes 87 which are at least partly included in the rectangular area 52 including the area stroke 5A, a plurality of third strokes 89 (i.e. “sample a”, “>sample b” and “>sample c”) which belong to the same groups as the plural first strokes 87. The target block 84 further includes an image part (first part) 86 included in the first area corresponding to the area stroke 5A. The third strokes 89 are strokes which were handwritten continuous with the plural first strokes 87.

A target block 91 illustrated in FIG. 14 includes a plurality of strokes 87 which are at least partly included in the rectangular area 52 including the area stroke 5A, and an image part (first part) 95 included in this rectangular area.

A target block 92 includes a plurality of first strokes 87 which are at least partly included in the rectangular area 52 including the area stroke 5A, and a plurality of second strokes 88 (i.e. “sample a” and “>sample b”) which were handwritten during the period in which the plural first strokes 87 were handwritten. The target block 92 further includes an image part (first part) 96 corresponding to a rectangular area including the first strokes 87 and second strokes 88.

A target block 93 includes a plurality of first strokes 87 which are at least partly included in the rectangular area 52 including the area stroke 5A, and a plurality of third strokes 89 (i.e. “sample a”, “>sample b” and “>sample c”) which belong to the same groups as the plural first strokes 87. The target block 93 further includes an image part (first part) 97 corresponding to a rectangular area including the first strokes 87 and third strokes 89.

The selector 306 selects one or more stroke data and image data corresponding to a selected target block (i.e. selected one or more strokes and image part) from a plurality of stroke data (time-series information) corresponding to a plurality of strokes in the handwritten document 50, and image data corresponding to one or more images. The selected one or more stroke data and image data are, for example, a copy of a part of the plural stroke data (time-series information) and a copy of a part of the image data corresponding to the one or more images. The selected stroke data and image data are temporarily stored, for example, in the working memory 401. In the meantime, the selector 306 may generate data of an image (clipping image) in which the selected stroke and image part (first part) are drawn and store the generated data. In addition, the data storage processor 307 may store in the storage medium 402 the stroke data and image data which are temporarily stored in the working memory 401.

The selector 306 further reads the temporarily stored stroke data and image data in accordance with an area paste operation using the touch-screen display 17. The read stroke data and image data are sent to the area display processor 305. The area display processor 305 analyzes the stroke data and displays (draws) in a target document the locus of each stroke indicated by the stroke data and an image indicated by the image data, based on the analysis result. This target document is a document which is set in an active state when the area paste operation is executed, and is, for example, the handwritten document (first document) 50 or a handwritten document (second document) which is different from the handwritten document 50.

In the meantime, when a plurality of candidate areas are displayed on the handwritten document 50, the area display processor 305 may effect such display that the strokes and image part (first part), which are obtained (cut out) when each of the plural candidate areas was selected, can be discriminated by the user.

By the above-described configuration, the user can easily select not only the area corresponding to the area stroke 5A, which is input by the area input operation, but also the areas relating to the area stroke 5A. In addition, by pasting the strokes and image, which correspond to the selected area, on the handwritten document 50 or another handwritten document, the user can easily execute edit of handwritten documents, such as reconstruction of the handwritten document 50 or integration of a plurality of handwritten documents.

The above description has been given of the example in which the object is an image. However, another object disposed in the handwritten document 50 can also be selected in accordance with the area input operation. For example, when one or more objects are included in the handwritten document 50, the selector 306 selects an object of the one or more objects based on the area stroke 5A. Then, the selector 306 selects object data corresponding to the selected object, from among one or more object data corresponding to the one or more objects, and temporarily stores the selected object data in the storage medium 402. Incidentally, in the case of an object of a character string such as a file path or URL, if a part of the characters is lost, access to a file or a link is disabled. Thus, in the case of the handwritten document 50 including the object of the character string, the selector 306 may select, for example, the entirety of the object which is at least partly included in the first area corresponding to the area stroke 5A. In addition, when a first object, which is not included in the first area corresponding to the area stroke 5A, is associated with a stroke or an image (object) in the first area, the selector 306 may select this first object (object data corresponding to the first object).

In addition, the candidate area calculator 304 can also calculate an area including an offset using information of positions (coordinates) at which a plurality of strokes in the handwritten document 50 were handwritten, so that a semantic relation between the strokes may be complemented.

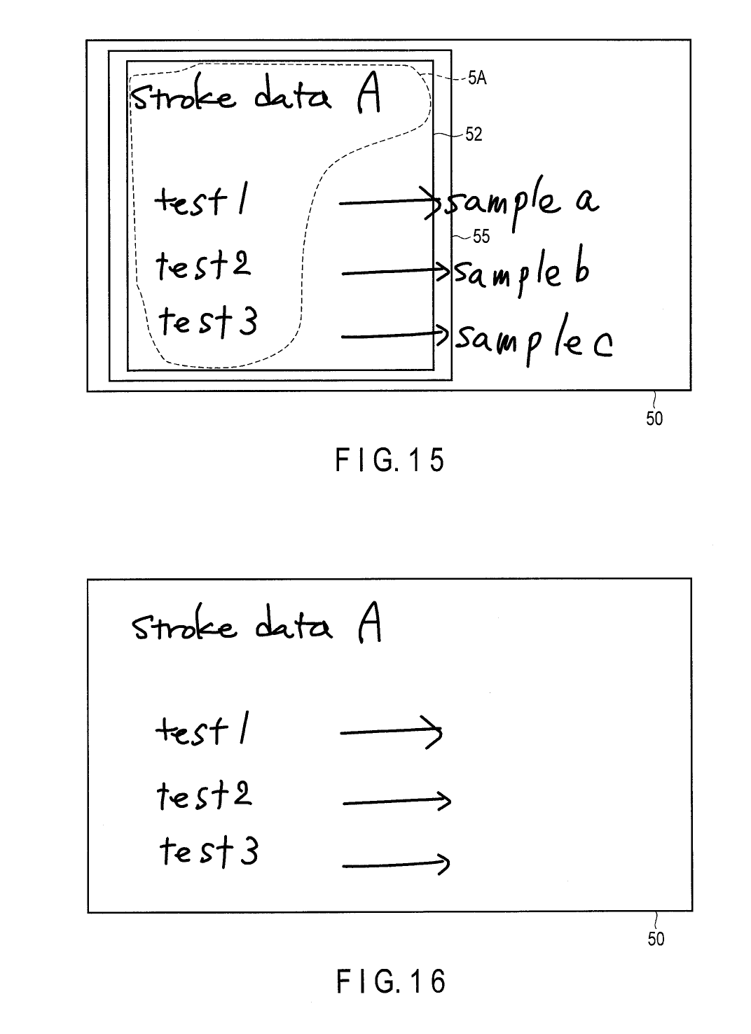

As illustrated in FIG. 15, the candidate area calculator 304 calculates, for example, an area 55 which is obtained by enlarging the rectangular area (second candidate area) 52 including the area stroke 5A by an offset based on a character size. Alternatively, the candidate area calculator 304 calculates an area which is obtained by reducing the rectangular area (second candidate area) 52 by this offset. For example, the candidate area calculator 304 calculates a maximum value (e.g. pixel unit) of the height and width of each stroke in the handwritten document 50, or a mean value of the height and width of each stroke, as a character size (a size of one side of the rectangle circumscribing a character) intended by the user. Incidentally, as this character size, it is possible to set an arbitrary value in a range from the minimum value to the maximum value of the height and width of plural strokes in the handwritten document 50.

Thereby, as illustrated in FIG. 16, the area selector 306 selects, for example, strokes included in the area 55 which is enlarged by an offset corresponding to one character, and then selects stroke data corresponding to the selected strokes from among plural stroke data corresponding to the plural strokes in the handwritten document 50. In the meantime, the offset used for enlargement or reduction is not limited to the offset corresponding to one character, and may be an offset corresponding to a plurality of characters.

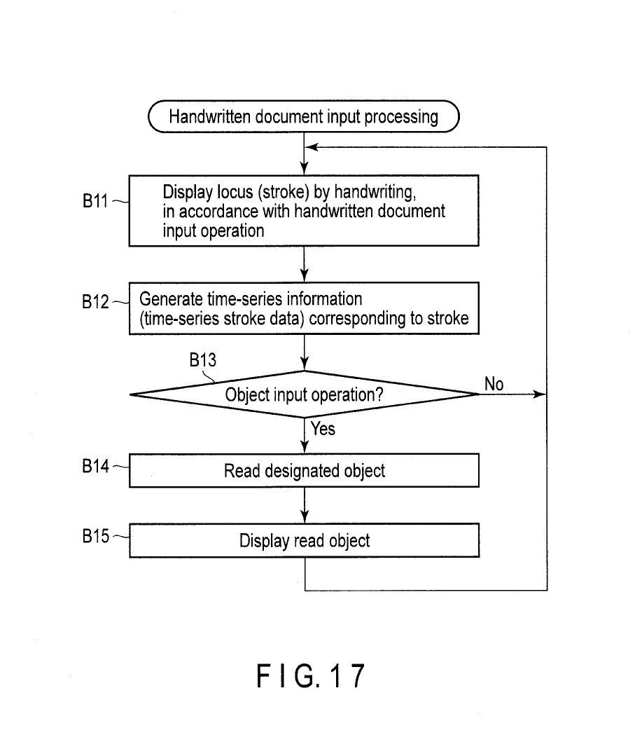

Next, referring to FIG. 17, a description is given of an example of the procedure of a handwriting input process executed by the digital notebook application 202. In this example, it is assumed that the digital notebook application 202 is set in a first mode for inputting a handwritten document (handwritten character or graphic).

To start with, the locus display processor 301 displays on the display 17A the locus (stroke) of movement of the pen 100 or the like by a document input operation (block B11). In addition, the time-series information generator 302 generates the above-described time-series information (a plurality of stroke data arranged in time series) based on coordinate series corresponding to the locus by the document input operation (block B12). The time-series information generator 302 may temporarily store the time-series information in the working memory 401.

Subsequently, the object reader 310 determines whether an object input operation for inserting various objects (an image, a graphic object, a file path, an icon, a URL, a formula, a graph, etc.) in the handwritten document has been detected or not (block B13). When the object input operation is not detected (NO in block B13), the process returns to block B11, and the input of a handwritten document corresponding to a handwritten document input operation is continued.

When the object input operation has been detected (YES in block B13), the object reader 310 reads the object, which has been designated by the object input operation, from the storage such as the storage medium 402 (block B14). This object may be read from storage of a server over a network. The object display processor 311 displays the read object on the handwritten document on the display 17A (block B15). In this object input operation, the position at which the object is displayed, or the size of the object, may be designated. Incidentally, the object reader 310 may temporarily store object information indicative of the inserted object (e.g. a file path of an image, identification information of a graphic object, a position and size of an object, etc.) in the working memory 401.

Further, the data storage processor 307 stores the time-series information generated by the time-series information generator 302 (the time-series information temporarily stored in the working memory 401) and the information read by the object reader 310 (the object information temporarily stored in the working memory 401) as handwritten document data in the storage medium 402.

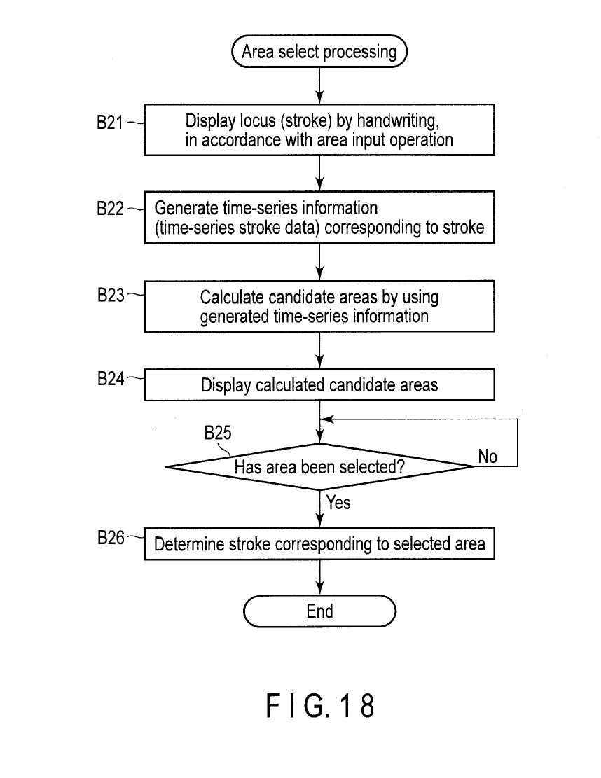

FIG. 18 illustrates an example of the procedure of an area select process executed by the digital notebook application 202. In this example, it is assumed that the digital notebook application 202 is set in a second mode for selecting an area in a handwritten document.

To start with, the locus display processor 301 displays on the display 17A the locus (area stroke) of movement of the pen 100 or the like by an area input operation (block B21). In addition, the time-series information generator 302 generates the above-described time-series information (one stroke data) based on coordinate series corresponding to the locus by the area input operation (block B22). The time-series information generator 302 may temporarily store the time-series information in the working memory 401.

Subsequently, the candidate area calculator 304 calculates candidate areas on the handwritten document by using the generated time-series information (area stroke) (block B23). The area display processor 305 displays the calculated candidate areas on the display 17A (block B24).

The selector 306 determines whether one area has been selected from among the candidate areas based on the area input operation (block B25). If no area has been selected (NO in block B25), the process returns to block B25, and it is determined once again whether an area has been selected or not.

When an area has been selected (YES in block B25), the selector 306 determines one or more strokes (and image part) in the handwritten document, which correspond to the selected area (block B26). The selector 306 acquires, for example, stroke data corresponding to the determined one or more strokes (and image data corresponding to the selected image part). Thereby, the user can instruct the digital notebook application to cut out arbitrary strokes (and image part) from the handwritten document, and to paste the cut-out strokes (and image part) on another area in this handwritten document or on another document.

As has been described above, according to the present embodiment, a handwritten document can easily be handled. The locus display processor 301 displays on the screen an area stroke for designating a first area, when a first document including a plurality of strokes corresponding to a handwritten document input operation and one or more images is displayed on the screen. The selector 306 selects first stroke data corresponding to a first stroke of the plural strokes and first image data corresponding to a first part in the one or more images based on the area stroke.

The user inputs an area stroke (freehand object) which designates an arbitrary area on the screen on which the handwritten document is displayed, by an operation using a pointing device such as a touch operation, a stylus operation or a mouse operation. In accordance with the input, strokes and an image (object) in the handwritten document, which correspond or relate to this area stroke, are acquired. Then, the user can use the acquired strokes and image by pasting them on another area in this handwritten document or on another document.

All the procedures in the present embodiment, which have been described with reference to flowcharts of FIGS. 17 and 18, can be executed by software. Thus, the same advantageous effects as with the present embodiment can easily be obtained simply by installing a computer program, which executes the process procedures, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display processor configured to display an area stroke inputted by a user on a screen based upon a display of a first document comprising a plurality of handwritten strokes and one or more images, the area stroke designating a first area; and
a selector configured to select first stroke data and first image data based on the area stroke, wherein the first stroke data corresponds to a first stroke among the plurality of handwritten strokes, and the first image data corresponds to a first part in the one or more images.

2. The electronic apparatus of claim 1, further comprising a storage processor configured to store the first stroke data and the first image data in a storage medium.

3. The electronic apparatus of claim 1, wherein
the selector is configured to select first stroke data and first image data,
the first area comprises a first stroke among the plurality of strokes and a first part in the one or more images,
the first stroke data corresponds to the first stroke, and
the first image data corresponds to the first part.

4. The electronic apparatus of claim 1, wherein
the selector is configured to select first stroke data and first image data,
a rectangular area comprising the first area at least partly comprises a first stroke among the plurality of strokes,
the first stroke data corresponds to the first stroke,
the first area comprises a first part in the one or more images, and
the first image data corresponds to the first part.

5. The electronic apparatus of claim 1, wherein
the selector is configured to select first stroke data, second stroke data and first image data,
a rectangular area comprising the first area at least partly comprises a plurality of first strokes among the plurality of strokes,
the first stroke data corresponds to the plurality of first strokes,
the second stroke data corresponds to a second stroke which was handwritten during a period in which the plurality of first strokes were handwritten,
the first area comprises a first part in the one or more images, and
the first image data corresponds to the first part.

6. The electronic apparatus of claim 1, further comprising a dividing module configured to divide the plurality of strokes into a plurality of groups based on time when the plurality of strokes were handwritten,
wherein the selector is configured to select first stroke data, second stroke data and first image data,
a rectangular area comprising the first area at least partly comprises a plurality of first strokes among the plurality of strokes,
the first stroke data corresponds to the plurality of first strokes,
the second stroke data corresponds to a second stroke which belongs to the same group as the plurality of first strokes,
the first area comprises a first part in the one or more images, and
the first image data corresponds to the first part.

7. The electronic apparatus of claim 1, wherein
the selector is configured to select first stroke data and first image data,
a rectangular area comprising the first area at least partly comprises a first stroke among the plurality of strokes,
the first stroke data corresponds to the first stroke,
the rectangular area further comprises a first part in the one or more images, and
the first image data corresponds to the first part.

8. The electronic apparatus of claim 1, wherein
the first document further comprises one or more objects, and
the selector is configured to further select object data based on the area stroke, wherein the object data corresponds to an object among the one or more objects.

9. The electronic apparatus of claim 1, wherein
the display processor is configured to further display a rectangular area comprising the first area on the screen, and
the selector is configured to select, when the first area was selected by an area select operation of selecting either the first area or the rectangular area, first stroke data and first image data, wherein
the first area comprises a first stroke among the plurality of strokes and a first part in the one or more images,
the first stroke data corresponds to the first stroke,
the first image data corresponds to the first part, and
the selector is configured to select, when the rectangular area was selected by the area select operation, first stroke data and first image data, wherein the rectangular area at least partly comprises the first stroke among the plurality of strokes, the first stroke data corresponds to the first stroke, the first area comprises a first part in the one or more images, and the first image data corresponds to the first part.

10. The electronic apparatus of claim 1, wherein the display processor is configured to further display the first stroke and the first part in the first document or in a second document different from the first document in accordance with a paste operation, wherein
the first stroke corresponds to the first stroke data, and
the first part corresponds to the first image data.

11. The electronic apparatus of claim 1, further comprising a touch-screen display,
wherein the plurality of handwritten strokes and the area stroke are input using the touch-screen display.

12. A handwritten document processing method comprising:
displaying an area stroke inputted by a user on a screen based upon a display of a first document comprising a plurality of handwritten strokes and one or more images, the area stroke designating a first area; and
selecting first stroke data and first image data based on the area stroke, wherein the first stroke data corresponds to a first stroke among the plurality of strokes, and the first image data corresponds to a first part in the one or more images.

13. A computer-readable, non-transitory storage medium comprising a program configured to be executed by a computer, the program controlling the computer to execute functions of:
displaying an area stroke inputted by a user on a screen based upon a display of a first document comprising a plurality of handwritten strokes and one or more images, the area stroke designating a first area; and
selecting first stroke data and first image data based on the area stroke, wherein the first stroke data corresponds to a first stroke among the plurality of strokes, and the first image data corresponds to a first part in the one or more images.
